(19) United States
(12) Patent Application Publication
(10) Pub. No.: US 2003/0051963 A1
(43) Pub. Date: Mar. 20, 2003

(54) One-way clutch assembly

(75) Inventor: Hiroyuki Ohishi, Hamakita-shi (JP)

Correspondence Address: CROWELL & MORING LLP, INTELLECTUAL PROPERTY GROUP, P.O. BOX 14300, WASHINGTON, DC, 20044-4300, US

(73) Assignee: NSK-Warner K.K., Shinagawa-ku (JP)

(21) Appl. No.: 10/244,556

(22) Filed: Sep. 17, 2002

(30) Foreign Application Priority Data
Sep. 17, 2001 (JP) 2001-281232

(51) Int. Cl. F16D 41/07

(52) U.S. Cl. 192/45.1; 192/113.32

(57) ABSTRACT

A one-way clutch assembly includes a one-way clutch having an outer ring, an inner ring, sprags and a sprag cage and also a rolling bearing. The one-way clutch assembly also includes a sealing material such as silicone bond, a sealing member such as an O-ring, or an oil retainer for establishing sealing at a boundary between a retainer arranged on an end wall of the one-way clutch and an inner circumferential wall of the outer ring.

### BACKGROUND OF THE INVENTION

a) Field of the Invention

This invention relates to a one-way clutch assembly with a rolling bearing arranged in combination, which is equipped with improved retainability for lube oil and permits a reduction in the friction to be produced on an outer circumferential wall of an inner ring.

b) Description of the Related Art

FIG. 7 is an axial fragmentary cross-sectional view of a one-way clutch assembly 10 with a conventional rolling bearing arranged in combination, and shows an outer ring 1, an inner ring 2, splines 21 formed on an inner peripheral wall of the inner ring 2, lubrication holes 22, a retainer 3, sprags 4, sprag cages 41, a ribbon spring 6, a rolling bearing 30 interposed between the inner ring 2 and the outer ring 1, balls 31, and a snap ring 32.

When a one-way clutch is used in association with an automobile engine or the like, the one-way clutch is subjected to high-speed rotation as many as several thousands revolutions (in some instances, 10,000 revolutions or more) per minute. As a result, lube oil may flow out between an outer ring and a retainer under centrifugal force, resulting in insufficient lube oil on sliding surfaces.

As an inner ring and the outer ring rotate at high speed relative to each other, a rolling bearing (ball bearing) is arranged in combination between the inner ring and the outer ring. Due to the existence of a space within the rolling bearing and the existence of a clearance between the inner ring and the outer ring of the one-way clutch, there is an unavoidable drawback that tilting of the outer ring of the one-way clutch results in tilting of sprags and under insufficient lube oil, this tilting of the sprags causes considerable wearing on an outer circumferential wall of the inner ring.

In FIG. 7, lube oil flows out of a clearance between the retainer 3 and the outer ring 1 at a location indicated by numeral 42 under centrifugal force. Arrows p designate the lube oil flowing out of the clearance.

### SUMMARY OF THE INVENTION

To solve the above-described problem, the present invention provides a one-way clutch assembly including a one-way clutch having an outer ring, an inner ring, sprags and a sprag cage and also a rolling bearing, comprising sealing means for establishing sealing at a boundary between a retainer arranged on an end wall of the one-way clutch and an inner circumferential wall of the outer ring.

The sealing means can be a sealing material such as silicone bond interposed at the boundary between the retainer and the inner circumferential wall of the outer ring; a sealing member such as an O-ring interposed at the boundary between the retainer and the inner circumferential wall of the outer ring; or an oil retainer arranged at the boundary between the retainer and the inner circumferential wall of the outer ring.

The outer ring and the inner ring rotate at high speed relative to each other, so that lube oil tends to flow out between the outer ring and the retainer under centrifugal force. As the one-way clutch assembly according to the present invention has the above-described construction, it is equipped with improved retainability for lube oil. It is, therefore, possible to prevent lube oil from becoming insufficient on sliding surfaces.

### BRIEF DESCRIPTION OF THE DRAWINGS

FIG. 1 is a partly cut-off end view of a one-way clutch assembly according to a first embodiment of the present invention;

FIG. 2 is an axial cross-sectional view of the one-way clutch assembly according to the first embodiment of the present invention taken along line II-O-II of FIG. 1;

FIG. 3 is similar to FIG. 2 but illustrates a one-way clutch assembly according to a second embodiment of the present invention;

FIG. 4 is an enlarged fragmentary cross-sectional view of a clutch section in the one-way clutch assembly of FIG. 2;

FIG. 5 is a fragmentary axial cross-sectional view of a one-way clutch assembly according to a third embodiment of the present invention, in which sealing is established with silicone bond between a retainer and an outer ring;

FIG. 6 is a fragmentary axial cross-sectional view of a one-way clutch assembly according to a fourth embodiment of the present invention, in which sealing is established with an O-ring between a retainer and an outer ring; and

FIG. 7 is a fragmentary axial cross-sectional view of a conventional one-way clutch assembly.

### DETAILED DESCRIPTION OF THE INVENTION AND PREFERRED EMBODIMENTS

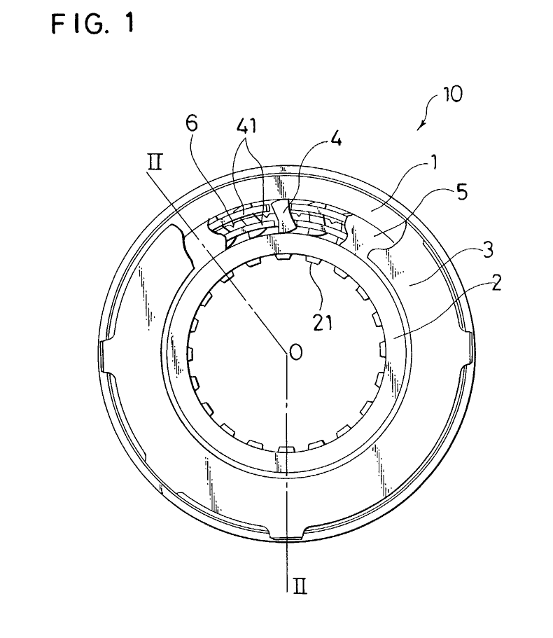

Referring to FIGS. 1, 2 and 4, the one-way clutch assembly 10 will be described firstly. In these drawings, there are illustrated an outer ring 1, an inner ring 2, splines 21 formed on an inner peripheral wall of the inner ring 2, lubrication holes 22, a retainer 3, sprags 4, sprag cages 41, a ribbon spring 6, a rolling bearing 30 interposed between the inner ring 2 and the outer ring 1, balls 31, and a snap ring 32.

As mentioned above, the outer ring 1 and the inner ring 2 rotate at high speed relative to each other. Accordingly, lube oil which enters the one-way clutch through the lubrication holes 22 tends to flow out between the outer ring 1 and the retainer 3 under centrifugal force, possibly resulting in insufficient lube oil on sliding surfaces.

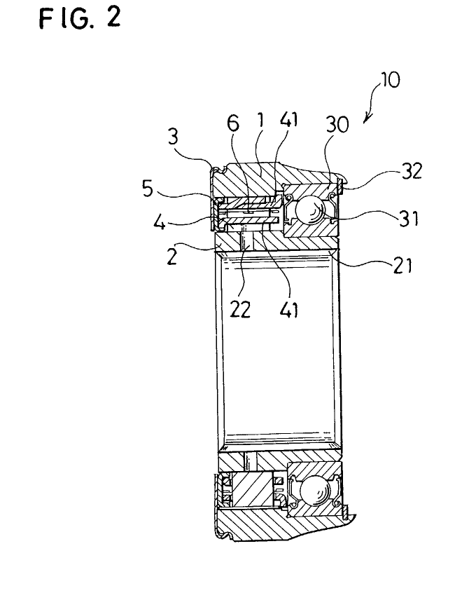

In this first embodiment, an oil retainer 5 is arranged at a boundary between the retainer 3 and an inner circumferential wall of the outer ring 1. As illustrated in FIGS. 2 and 4, the oil retainer 5 has a turned, flattened, square U shape in cross-section. An outer circumferential end portion 51 of the oil retainer 5 is in close contact with the inner circumferential wall of the outer ring 1, while an inner circumferential end portion 52 of the oil retainer 5 is located with a clearance 25 defined between the inner circumferential end portion 52 and the outer circumferential wall of the inner ring 2. The width d of this clearance 25 is set such that the inner circumferential end portion 52 of the oil retainer 5 remains out of contact with the outer circumferential wall of the inner ring 2 even when the oil retainer 5 is caused to tilt due to the existence of a space within the rolling bearing 30 and a clearance between the inner ring 2 and an inner ring of the rolling bearing 30. Even in a high-speed rotation range, this clearance 25 prevents the oil retainer 5 from contacting the outer circumferential wall of the inner ring 2 and therefore, from being seized on the outer circumferential wall of the inner ring 2. In FIG. 4, letter K indicates a permissible range of the tilting of the oil retainer 5.

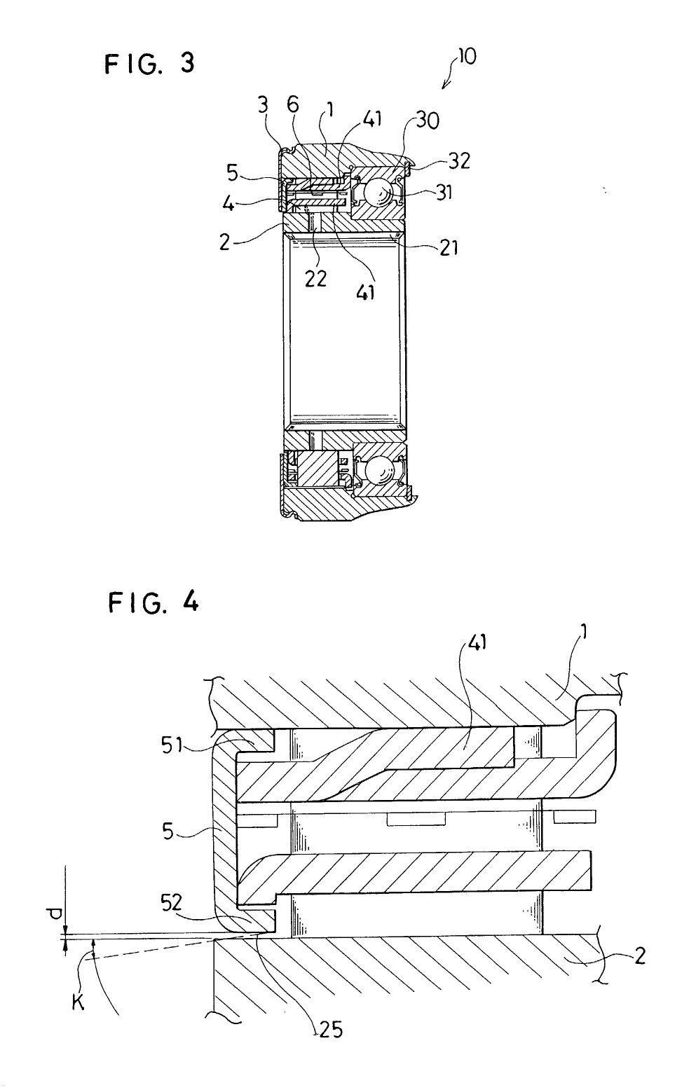

The one-way clutch assembly according to the second embodiment of the present invention, which is illustrated in FIG. 3, is different only in the shape of the oil retainer 5 from the one-way clutch assembly according to the first embodiment of the present invention depicted in FIGS. 1, 2 and 4. In FIGS. 1 through 4, like reference numerals indicate like elements of structure. In the second embodiment shown in FIG. 3, the oil retainer 5 has an L shape in cross-section.

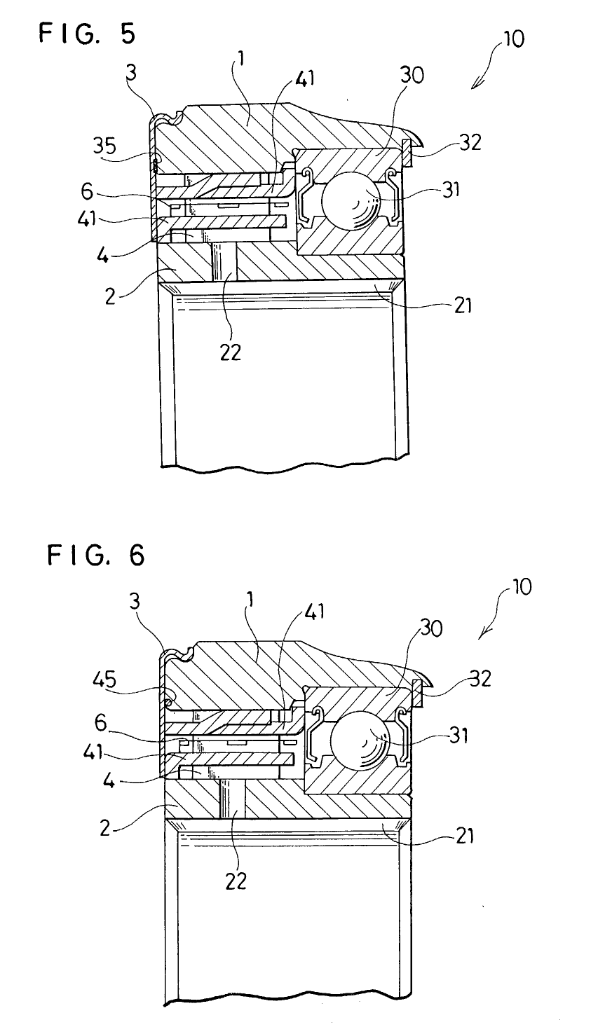

The one-way clutch assembly according to the third embodiment of the present invention will next be described with reference to FIG. 5. As a sealing material, silicone bond 35 is applied between a retainer 3 and an end wall of an outer ring 1. This end wall is located facing the retainer 3.

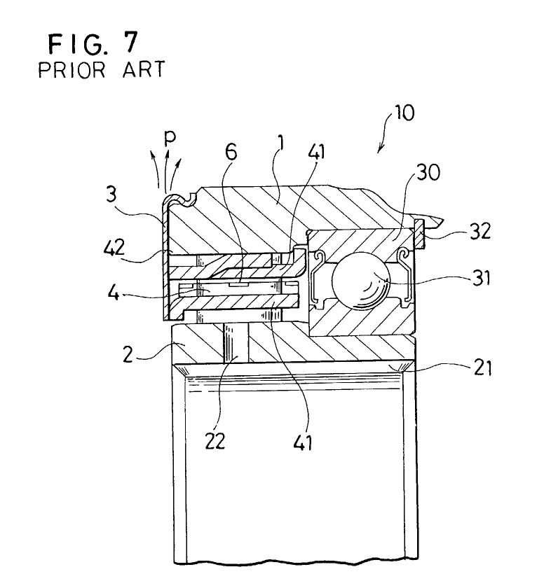

Reference will next be had to FIG. 6, which illustrates the one-way clutch assembly according to the fourth embodiment of the present invention. As a sealing member, an O-ring 45 is fitted in a circumferential groove formed in an end wall of an outer ring 1. This end wall is also located facing the retainer 3.

This application claims the priority of Japanese Patent Application 2000-281232 filed Sep. 17, 2001, which is incorporated herein by reference.

What is claimed is:

1. A one-way clutch assembly including a one-way clutch having an outer ring, an inner ring, sprags and a sprag cage and also a rolling bearing, comprising sealing means for establishing sealing at a boundary between a retainer arranged on an end wall of said one-way clutch and an inner circumferential wall of said outer ring.

2. A one-way clutch assembly according to claim 1, wherein said sealing means is a sealing material interposed at said boundary between said retainer and said inner circumferential wall of said outer ring.

3. A one-way clutch assembly according to claim 2, wherein said sealing material is silicone bond applied between said retainer and an end wall of said outer ring, said end wall being located facing said retainer.

4. A one-way clutch assembly according to claim 1, wherein said sealing means is a sealing member interposed at said boundary between said retainer and said inner circumferential wall of said outer ring.

5. A one-way clutch assembly according to claim 4, wherein said sealing member is an O-ring fitted in a circumferential groove formed in an end wall of said outer ring, said end wall being located facing said retainer.

6. A one-way clutch assembly according to claim 1, wherein said sealing means is an oil retainer arranged at said boundary between said retainer and said inner circumferential wall of said outer ring.

7. A one-way clutch assembly according to claim 6, wherein said oil retainer is arranged between said inner circumferential wall of said outer ring and an outer circumferential wall of said inner ring and also between said retainer and said sprag cage, and is provided with an outer circumferential end portion maintained in slidable contact with said inner circumferential wall of said outer ring.

8. A one-way clutch assembly according to claim 7, wherein said oil retainer is provided with an inner circumferential end portion, and said inner circumferential end portion and said outer circumferential wall of said inner ring define therebetween a clearance sufficient to keep said inner circumferential end portion of said oil retainer out of contact with said outer circumferential wall of said inner ring even when said oil retainer is caused to tilt.
